(19) United States
(12) Patent Application Publication
(10) Pub. No.: US 2014/0156320 A1
(43) Pub. Date: Jun. 5, 2014

(54) PRICING AND MANAGING ACCESS RIGHTS IN A VENUE

(71) Applicant: K41, Inc., New York, NY (US)

(72) Inventor: David N. Levin, New York, NY (US)

(73) Assignee: K41, Inc., New York, NY (US)

(21) Appl. No.: 14/088,222

(22) Filed: Nov. 22, 2013

Related U.S. Application Data
(60) Provisional application No. 61/733,318, filed on Dec. 4, 2012.

(51) Int. Cl. G06Q 10/02

(52) U.S. Cl. CPC G06Q 10/02
USPC 705/5

(57) ABSTRACT

In a method and system for managing access rights, a listing for each of a plurality of access rights is received, and a request for a desired access right from a user is received, wherein the request includes a desired time period and a desired resource. A matching access right of the plurality of access rights is determined. Upon determining that an access right is not available, the request is placed on a standby list and a standby notification is sent to the user, including a position on the standby list, wherein the matching access right is reserved for the user when the request is in a top position on the standby list.

### CROSS-REFERENCE TO RELATED APPLICATION

This application claims the benefit of U.S. Provisional Application Ser. No. 61/733,318 filed on Dec. 4, 2012, which is hereby incorporated by reference.

### TECHNICAL FIELD

Embodiments of the present invention relate generally to reservation systems and, more specifically, to a system and corresponding methods for managing access rights to venues.

### BACKGROUND

A lack of availability to access rights to a venue can impact a consumer base for the venue, which in turn impacts the venue's success and future growth. Consumers, particularly those that are considered to be a venue's best customers or those that are classified as target customers, often demand a high level of service and can be willing to pay for an access right to get the desired level of service. Accordingly, a system that provides availability to access rights can provide for increased patronage. Further, access rights for smaller venues, such as dining establishments, may not even be ascribed a value and, thus, may not be properly monetized.

Current implementations of reservation and booking systems are deficient in addressing the foregoing pricing concerns and consumer demands. These deficiencies lead to venues establishing inefficient manual processes for managing peak demand despite limited supply. In view of the foregoing, there is a need for an improved system for pricing and managing access rights for venues.

### SUMMARY

An embodiment provides a method that includes receiving a listing for each of a plurality of access rights, wherein each of the plurality of access rights has a corresponding time, a corresponding resource, and a corresponding access fee, and receiving a request for a desired access right from a user, wherein the request includes a desired time period and a desired resource. The method further includes determining a matching access right of the plurality of access rights, wherein the corresponding time of the matching access right is within the desired time period and the corresponding resource of the matching access right matches the desired resource. The method determines that the access right is not available, and places the request in a position on a standby list. A standby notification is sent to the user, where the standby notification include the position on the standby list. The matching access right is reserved for the user upon the matching access right becoming available when the request is in a top position on the standby list.

Upon reservation of the matching access right for the user, a request can be sent to the user to accept or decline the reservation. Upon receipt of an acceptance of the reservation by the user, the matching access right can be assigned to the user. Upon receipt of a declination of the assignment by the user, the reservation of the matching access right can be canceled such that the matching access right is available for another user. The reservation can be canceled when the acceptance of the reservation is not received within an acceptance time period.

The method can include requesting payment of the corresponding access fee by the user upon acceptance of the reservation of the matching access right, wherein the assigning of the matching access right is upon receipt of the corresponding access fee. The method can also include receiving an aspect for the corresponding access fee, wherein the corresponding access fee is based on the aspect. The method can additionally include receiving an aspect for the standby list, wherein the position on the standby list is based on the aspect.

When the user accepts the reservation and does not use the access right at the corresponding time, the user can be assessed a cancellation fee.

### BRIEF DESCRIPTION OF THE DRAWINGS

The present disclosure will be understood more fully from the detailed description given below and from the accompanying drawings of various embodiments of the disclosure.

FIG. 1 illustrates exemplary system architecture, in accordance with an embodiment of the present disclosure.

FIG. 2 illustrates an access right management system, in accordance with an embodiment of the present disclosure.

FIG. 3 is a flow diagram illustrating an embodiment for a method of managing access rights.

FIG. 4 is a flow diagram illustrating an embodiment for another method of managing access rights.

FIG. 5 is a block diagram of an exemplary computer system that may perform one or more of the operations described herein.

### DESCRIPTION

Embodiments of the present invention provide a method and system for managing access rights. Listings for each of a plurality of access rights, along with a corresponding time and resource are received, for example, from an access right holder. Requests for desired access rights can be received from one or more users, where each request includes a desired time period and a desired resource. Matching access rights can be then determined. If the matching access right is not available, the request is placed on a standby list and a standby notification, including a position on the standby list, is sent to the user. The matching access right can be reserved for the user on the standby list upon the matching access right becoming available when the request is in a top position on the standby list. In an embodiment, an access fee can be assessed for the access right. For example, the access fee can be variable and can be assessed based on days of the week, seasonality, specific dates or times, quantity of access rights to be purchased, and/or a specific subset of the resource.

The access rights can be for restaurant seating, airline seat allocation, entertainment or sporting venue seating, parking spaces, hotel rooms, rental cars, or any other applicable venue where reservations are typically employed. In an embodiment, the access rights can be for other highly sought item, such as certain cars, designer bags, and designer apparel.

The purpose of embodiments of this invention is to give a service provider a way of providing access to an oversubscribed service through a configurable standby queuing mechanism. This mechanism would allow the provider to maximize revenue for the service by such means as elastically pricing access to the service and enhancing customer loyalty (e.g., resulting in customers returning more frequently) by providing confidence in the queuing system and priority queuing as a reward for frequent patronage.

For the customer, access to the oversubscribed service is made easier by being able to request access to the service over a range of dates and times (and other criteria specific to the type of service), and the system will allow the service provider to grant access to the customer at a time that is optimal for both parties. The system can also provide a notification and payment workflow for customers that will allow them to confirm their acceptance of the grant of access or refuse it and allow the next customer in the queue access to the service.

For example, the resource (or service) can be a restaurant at peak reservations times. The restaurateur can establish a set of times during the days that the restaurant is open for which a customer may enter a standby list (or queue) for a seating at that restaurant. Restaurateurs can also specify the quantity and size of each party that will be accepted at specific times. The restaurateur can also be permitted to establish access fees for access to the available slots or reservations. In an embodiment, the access fees can be based on data such as an average ticket, proximity to reservation date/time, slot availability, and/or demand for slots. In an embodiment, the access fee would be assessed when the customer is given access to and accepts an assigned slot.

In one example, the restaurateur, or the system manager, may choose to assign no access fee at all or a fixed access fee. In another example, the restaurateur, or the system manager, may assign access fees such that the access fee is higher when the requested date of access is closer to the date that the request is made, and lower when the request is made further in advance. In another example, the access fee can be a fixed percentage of the price of the service offered, based on the amount of demand for the service, and/or based on a position on a standby list. For example, the access fee could increase from 10% to 20% of the average price of the service being offered for each new person who joins the standby list. In another example, the restaurateur, or the system manager, can assign pricing such that the access fee is higher at more popular periods of the day and lower at less popular times. In an embodiment, historical or real-time data can be used to determine how popular certain requested slots are and automatically vary the pricing accordingly.

In an embodiment, the restaurateur or system manager provides only minimum and maximum party sizes, rather than providing availability for particular rights.

Once the restaurateur has provided the information on available dates and time ranges, a customer may search the system based on a set of specific criteria, which can include current location, party size, date and time range desired, and other potentially relevant attributes, including the name of the restaurant, type of cuisine or price range.

A list of options that matches the requested criteria is presented to the user. If none of the matching options is available, the position on the standby list the customer would take upon entering the standby list for each matching restaurant can also be displayed. The position displayed can be based on the number of people in that restaurant's standby list who have requested the same party size and who have also requested a time range that overlaps in whole or in part with that of the current customer.

So, for example, if a restaurant has a standby list for a given day of three parties of two people, with request times of 6 pm to 8 pm, 7 pm to 9 pm and 8 pm to 10 pm, and a customer requests a party of two people for any time between 6 pm and 10 pm, the request is number four on the standby list. However, if the customer requests a reservation for between 6 pm to 7:30 pm, the request is number three on the standby list because this request does not conflict with the 8 pm to 10 pm request.

In another embodiment, position in the standby list is displayed even if a matching option is available. For example, if the customer is interested in only one restaurant, then the customer could be shown in the top position on the standby list. If the customer is interested in more than one restaurant, the customer can be shown in a position in a standby list for each restaurant, where the customer could be shown in a top position for each restaurant where there is a matching option that is available.

In an embodiment, the customer can also be given a percentage likelihood (e.g., a “get rate”) that the customer will obtain an access right (e.g., reservation) based on the historical performance of that restaurant for that specific day, time, party size and number of requests on the standby list. Thus, a request with a narrower time range may appear higher on the standby list, but may decrease the chance of obtaining an access right. Other visual cues, such as color and directional arrows, can indicate a likelihood of getting an access right. In an embodiment, the customer can be placed on standby lists for various restaurants, though the customer will only be placed on a standby list for a particular restaurant once in a given time period. Once the customer is on a standby list, the customer can receive notification by email and/or SMS, based on the customer's chosen configuration (or preferences).

If the restaurateur established in advance how many parties of a specific size were desired at specific times, then access rights can be assigned to customers on a first-come, first-served basis. If there are multiple matching access rights, the customer can select among the matching access rights. In an embodiment, the system can assign the available access rights based on filling the “shoulder” times first, where the shoulder times are the times furthest from the peak hour (e.g., busiest time) of the restaurant. The restaurateur or system manager could set the peak hour, or the peak hour could be determined based on historical demand.

Alternatively, the restaurateur, through a user interface (UI), can view the size of standby lists for different party sizes and times, and then can request that one or multiple slots of specific time/party size combinations be filled. For example, if the restaurateur observes that there is a queue of 6 parties of 2 people and 4 parties of 4 people waiting for an 8 pm slot, the restaurateur can request that 2 parties of 2 people and 2 parties of 4 people at 8 pm be found from those available.

Once a matching access right has been reserved for the request, the customer can be notified (e.g., by email, SMS, and/or in-app notification) that the access right has been reserved. In an embodiment, the customer has a limited amount of time to respond to the notification and provide payment to be assigned to the access right. If the customer refuses the access right or does not respond within the specified time window, then the access right can be offered to the next eligible customer on the standby list.

If a customer accepts and pays for the access right, then the customer can be seated by the restaurant as desired, and conflicting requests by the same customer can be automatically deleted from other standby lists (e.g., a request by the same customer on the same day within a specific number of hours of the accepted access right).

If the customer cancels the access right after having already accepted and paid for it, then a refund or credit can be issued to the customer. In an embodiment, a refund or credit can be denied if the customer canceled too close to the time of the access right. The system can automatically attempt to refill the slot with the next eligible customer on the standby list (e.g., as if the first customer had refused the access right when it was initially offered).

In an embodiment, the system can charge a no-show fee to a customer that fails to cancel an assignment of an access right (e.g., without adequate notification) and does not use the access right.

According to an embodiment, access rights for some customers can be prioritized over others even if the other customers entered the standby list earlier. For example, a higher priority can be given to a customer that was on the standby list of a restaurant multiple times and never received an access right, a customer known to spend a large value specific services (e.g., purchases expensive wines often), or a customer that is a frequent visitor of the restaurant.

According to an embodiment, loyalty rewards can be offered, for example, that allow a customer to gain points for purchases and other interactions with the system such that points can be redeemed to gain priority access rights such as skipping ahead positions on the standby list. Notification of last-minute availabilities of an access right can be provided to customers based on restaurant-selected or system-selected criteria such as proximity to a restaurant, number of visits to the restaurant, or status-level within the system.

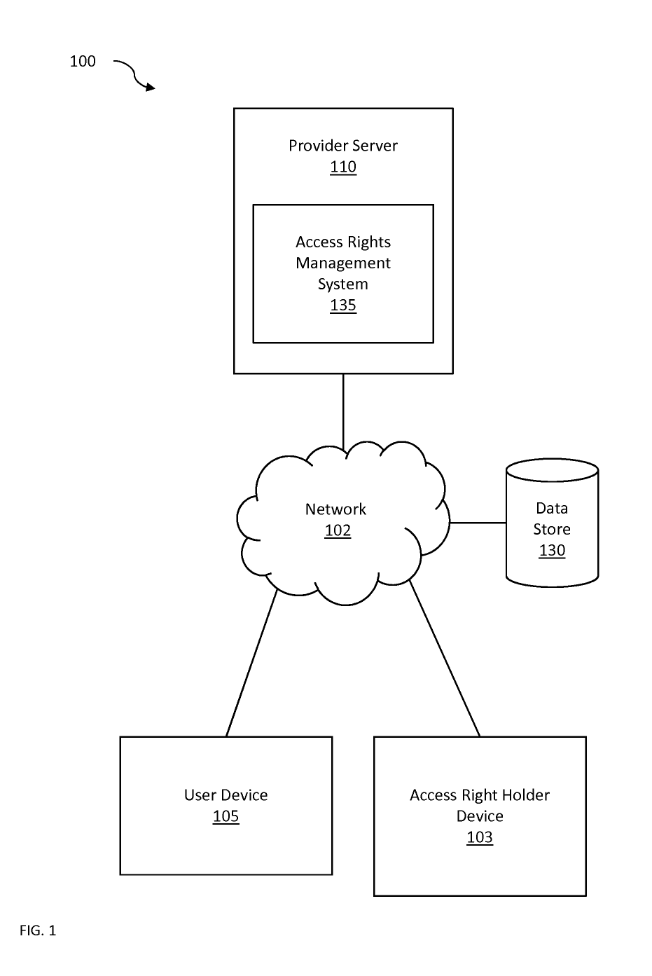

FIG. 1 illustrates exemplary system architecture 100, in accordance with one embodiment of the present disclosure. System 100 includes a user device 105 and an access right holder device 103 in communication with (e.g., coupled to) a provider server 110 over a network 102, and a data store 130. The network 102 may be a private network (e.g., a local area network (LAN), a wide area network (WAN), intranet, etc.), a corporate network (e.g., a private network for an organization such as a corporation), a broadcast network, a public network (e.g., the Internet), a wired network (e.g., Ethernet network), a wireless network (e.g., an 802.11 network) and/or a cellular network (e.g., a Long Term Evolution (LTE) network).

The user device 105 and the access right holder device 103 may be any type of computing device, for example, a device including a processor, a computer-readable medium, and a memory. In some embodiments, the user device 105 and access right holder device 103 may be executing a browser application or other application adapted to communicate over Internet related protocols (e.g., TCP/IP and HTTP) and/or display a user interface. While only a single user device 105 and a single access right holder device 103 are shown in FIG. 1, system 100 may support a large number of concurrent sessions with many user devices 105 and access right holder devices 103.

The provider server 110 may include computing devices that have a wide range of processing capabilities such a personal computer (PC), a server computer, a personal digital assistant (PDA), a smart phone, a laptop computer, a netbook computer, a tablet device, and/or any machine capable of executing a set of instructions (sequential or otherwise) that specify actions to be taken by that machine. Embodiments of the disclosure may operate within a single server device or on multiple server devices.

Data store 130 can include one or more writable persistent storage devices, such as memories, tapes or disks. Although each of provider server 110 and data store 130 are depicted in FIG. 1 as single, disparate components, these components may be implemented together in a single device or networked in various combinations of multiple different devices that operate together. Examples of devices may include, but are not limited to, servers, mainframe computers, networked computers, process-based devices, and similar type of systems and devices.

In an embodiment, the provider server 110 includes an access rights management system 135. During operation of system 100, the user device 105 and access right holder device 103 access the access rights management system 135 over network 102, where the provider server 110 receives communications from the user device 105 and the access right holder device 103, and processes and/or directs these communications accordingly.

An access right holder (e.g., a restaurateur) can use the access right holder device 103 to enter a list of access rights (e.g., reservation times) for one or more resources (e.g., restaurants) into the access rights management system 135.

A user can use the user device 105 to request a desired access right (e.g., a reservation) for a resource (e.g., a particular restaurant) from the access right management system 135. In the request, the user can specify one or more time periods, when applicable, (e.g., 8 pm-9 pm on Monday or 6 pm-10 pm on Friday). The request can also include a specification of one or more resources (e.g., Restaurant A, Restaurant B, or Restaurant A and B).

The access rights management system 135 can then determine whether the desired access right is available. If the desired access right is available (i.e., if an access right with a matching time period, when applicable, and resource is available), then the access right management system 135 can reserve the desired access right for the user and send a reservation notification to the user (e.g., by the user device 105 or other selected method, such as a text message). If the desired access right is unavailable (i.e., if no access right with a matching time period and resource are available), then the access right management system 135 can place the request on a standby list and notify the user (e.g., by the user device 105 or other selected method) of a position of the request on the standby list.

In another embodiment, the access rights management system 135 can first place the user's request on a standby list for each requested resource, and then notify the user of all of the matching access rights that are available. In one example, the user is able to view the position of the request in each standby list prior to an access right being reserved. In an example, the user is able to select whether to have a matching access right reserved or to remain on a standby list for another access right.

In an embodiment, before lists of access rights for resources have been received from access rights holders, user requests can first be placed in positions on standby lists for desired access rights for the resources. Based on the standby lists, the access right holders can then provide lists of access rights.

In another embodiment, the access right would not have a corresponding time associated with it. For example, if the access right was for an opportunity to purchase an item (e.g., a car, a designer bag, designer shoes, etc.) then there might not be a corresponding time. In this example, the request by the user would indicate one or more desired resources (e.g., particular models or colors for a car, particular sizes for shoes, etc.). The requests can then be placed in a position on a standby list, and a standby notification can be sent to the user. The matching access right (e.g., the opportunity to purchase the item) is reserved for the user when the request is in a top position on the standby list.

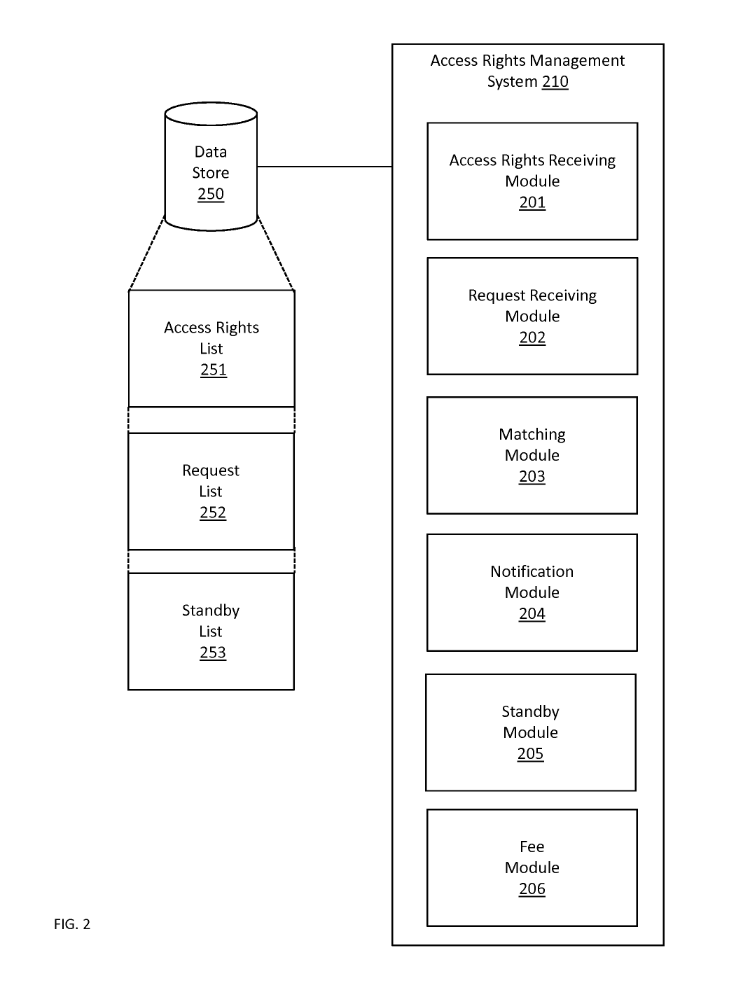

FIG. 2 illustrates an access rights management system 210, in accordance with an embodiment of the present disclosure. The access rights management system 210 may include an access rights receiving module 201, a request receiving module 202, a matching module 203, a notification module 204, a standby module 205, and a fee module 206. More or less components may be included in the access rights management system 210 without loss of generality. In an embodiment, access rights management system 210 is access rights management system 135 and data store 250 is data store 130, shown in FIG. 1.

In an embodiment, the access rights receiving module 201 receives information for access rights from one or more access right holders. The information for each access right can be stored in an access rights list 251 in data store 250. Each access right has a corresponding time, when applicable, and resource, and each access right can have additional information associated with the access right, such as VIP access, rules for standby list position, or rules for access fees.

In an example where the access rights are for a restaurant, a restaurateur can enter access rights, where each access right has a corresponding time (e.g., 8 pm, 8:30 pm, 9 pm, etc.) and a corresponding resource (e.g., Restaurant A, Restaurant B, Restaurant C, etc.). The restaurateur can enter additional information for each access right, such as how many people can use each access right (e.g., a table for 2, a table for 4, etc.).

Special access rights may be designated by the restaurateur based on manual designation or automatic filtering. For instance, the restaurateur may designate users as “VIPs” by manually labeling specific users as VIPs in the system. The restaurateur may set a minimum target frequency (e.g., users who dine three or more times at the restaurant in a given month) such that users who exceed this target are designated as “Frequent Diners”. The restaurateur may set rules to allow users designed as a VIP or Frequent Diner to reserve any, some, or all tables in the restaurant a specified number of days prior to other users not designated as a VIP and/or Frequent Diner. The restaurateur may set rules to provide special access fees for a VIP and/or Frequent Diner. The restaurateur may classify specific tables as a VIP and/or Frequent Diner tables. In an embodiment, a user can present an access code (e.g., a VIP or Frequent Diner access code) for validation. Upon validating the access code, early access, special pricing rules and exclusive access to the resource can be provided.

In an embodiment, the access rights holder or system manager can enter information regarding a fee associated with each access right. For example, a fee can be a fixed fee or a variable fee. A variable fee can vary based on the popularity of the access right (e.g., how many users are currently requesting that access right), proximity to the access right (e.g., access rights in the near future may have a higher fee than access rights in the distant future), desirability of access right based on historical popularity of the access right (e.g., weekend nights are generally more desired), proximity of the access right to a special event (e.g., a holiday), etc.

In the restaurant example, the restaurateur can indicate that the access fee is higher for an access right on Valentine's Day, an access right requested on the day of the access right, or an access right on a weekend night. For a week night, the restaurateur could indicate that the access fee is lower.

In an embodiment, the request receiving module 202 receives a request for a desired access right from a user. The request can be stored in a request list 252. The request can include a desired time period and a desired resource, as well as additional information, such as a desired number of people permitted by the access right.

In the restaurant example, the user can request a desired time period for a reservation (e.g., 8 pm-10 pm on Monday) and a desired resource (e.g., Restaurant A). The user can also indicate the number of people for the reservation (e.g., a table for 4).

In an embodiment, the matching module 203 can determine whether any access rights in the access rights list 251 match the desired access right requested by the user. The matching module 203 can determine if any of the access rights has a corresponding time within the desired time period and a corresponding resource matching the desire resource. The matching module 203 can also determine whether the access right matches any other aspects designated in the request, such as VIP access.

In the restaurant example, the matching module 203 can determine if a reservation is available for the desired number of people at the desired restaurant at the desired time. For example, if the user requested a reservation between 8 pm and 10 pm on Monday for 4 people at Restaurant A, the matching module 203 can determine if a matching access right is available in the access rights list 251.

If a matching access right is available, then the notification module 204 can notify the user that the matching access right is available. The notification module 204 can also notify the user of the corresponding time and the corresponding resource of the access right. If there is an access fee associated with the access right, then the fee module 206 can calculate the access fee based on information in the access rights list 251, and the notification module 204 can additionally notify the user of the access fee associated with the access right.

In an embodiment, the access right holder can indicate that additional information about the access right can be included in the notification. In one embodiment, the access right holder can provide special access rights for a shorter period of time than ordinary access rights. Further to the restaurant example, ordinary access right for a reservation can provide access for a certain time period (e.g., two hours). A special access right for a reservation for a shorter time period (e.g., one hour), sometimes referred to as an “out-by”, can be made available by the access right holder if there is a table that is available for the shorter period of time between ordinary reservations. For example, a particular table may be booked from 7 pm to 9 pm for one user and from 10 pm to midnight for another user. The restaurateur could provide an access right for a reservation from 9 pm to 10 pm. If a user has requested an access right in the time period of 8 pm to 10 pm, the user can receive a notification that a special access right meets the user's request, but, if the user accepts the special access right, the user is agreeing to vacate the table (i.e., be out by) 10 pm.

In the restaurant example, the user can be notified that a reservation is available for 9 pm on Monday for Restaurant A, and that an access fee of $10 is to be assessed for the access right. The user can also be notified that the access fee is to be paid before the reservation is assigned to the user. In an embodiment, the access fee can be automatically charged to a previously designated account, credit card, or debit card.

If a matching access right is not available, then the standby module 205 can put the request on the standby list 253 in the data store 250. The standby list 253 can have a number of positions where requests can be queued for access rights. The position of the request on the standby list can be at the end of the standby list for a particular access right, or the position on the standby list of the access right can be determined based on an aspect associated with the access right by the access right holder. For example, the aspect could be that certain users that enter an access code (e.g., a VIP code) with the request has a position that is higher on the standby list, that users who have previously submitted a request for an access right that was not granted have a higher position on the standby list, or that users that have previously spent a large monetary have a higher position on the standby list.

In the restaurant example, a user requesting a reservation can receive a notification that no matching reservations are available and that the user's request has been placed in a particular position on a standby list. Further, if the restaurateur had indicated that users that have previously spent large amounts at the restaurant should have a higher position on the standby list, then, if the user has previously spent large amounts, the request will be positioned on the standby list accordingly, and the user will be notified of the position. In another example, if the restaurateur had indicated that users that have previously been unsuccessful at securing a reservation should have a higher position on the standby list, then, if the user was previously unsuccessful at securing a reservation, the request will be positioned on the standby list accordingly and the user will be notified of the position.

If a request on the standby list 253 rises to the first (or top) position on the standby list 253, the standby module 205 will reserve the access right for that request if the access right becomes available. An access right can become available if another user cancels a reservation or does not confirm a reservation. Further, a matching access right can become available if the access right holder adds additional access rights. If an access right is reserved for a request on the standby list 253, then the notification module will notify the user of the reservation. If an access fee is associated with the access right, then the fee module 206 can calculate the access fee based on information in the access rights list 251, and the notification module 205 can also notify the user of the fee. In an embodiment, if the user does not confirm the reservation within a period of time (e.g., an hour), then the reservation is canceled.

In an embodiment, the access fee for a reservation on the standby list can be based on the same original access fee of the user who canceled the reservation, an increase or decrease of the original access fee, or proximity to the date of the seating reservation. If an access fee is not required, then the access right holder may designate whether a credit card is required to guarantee the reservation.

The access right holder or system manager may designate whether users can request a time range or a specific time when applicable. The access right holder or system manager may designate a maximum number of positions on a standby list for an access right. Alternate access rights can be recommended if a requested time or time range has reached a maximum number permitted on the standby list.

In an embodiment, the access right holder or system manager may enter a cancellation fee for specific access rights. The access right holder or system manager can establish a minimum and/or maximum cancellation fee, set rules to increase or decrease the cancellation fee at specific times, set rules that the cancellation fee will be waived if cancellation occurs a specific number of days or more prior to the date of the access right, set rules to increase or decrease the cancellation fee based on the number of days remaining prior to the date of the access right, and/or set rules to increase, decrease, or waive the cancellation fee for a partial no-show. The access right holder or system manager can also allow the system to determine the cancellation fee based on demand for access rights at the time of cancellation. The access right holder or system manager can also have the cancellation fee automatically determined based on historical demand for access rights. Whether there is a demand for the access right at the time of cancellation can be determined based on the number of access right requests made over a specified time interval, the number of access rights still available at the time of cancellation, a demand predicted by historical data, a combination thereof or any other suitable measure for assessing demand.

In an embodiment, a user could be notified of last-minute availabilities via the user's mobile phone, email, or another suitable method. Last-minute availability could result from a cancellation of an assignment of an access right within a certain period of time (e.g., 30 minutes or an hour) before the corresponding time of the access right. In one example, locations of users that have indicated interest in the resource with the last-minute availability (e.g., with a request on a standby list for the resource, by indicating general interest, by having indicated an interest in a similar resource, etc.) could be determined via the users' mobile phones (e.g., by accessing data on the mobile phones indicating positions of the mobile phones) or by addresses entered by the users. One or more users within a certain distance could then be notified of last-minute availabilities for that resource. The users that receive the notification would then be given a certain time period (e.g., 5 minutes or 10 minutes) to respond to the notification with an acceptance such that the user could be assigned to the access right. In the case where multiple users receive the notification, the first user to respond could be assigned the access right. If no user responds with the certain time period, then one or more users that are slightly farther away can be determined and be sent the notification. The distance from the resource can be increased to include additional users until a user responds or until the corresponding time of the access right occurs.

In an embodiment, VIPs or frequent users of the system can receive notification of the last-minute availability prior to other users or instead of other users.

In an embodiment, positions of requests in a standby list for a resource can be assigned based on rules for accommodating ordinary requests and requests from users that have been designated VIP. For example, VIP users' requests can be inserted on the standby list periodically. In one example, wherein the rule specifies that VIP users' requests are inserted after every three ordinary users' requests, the first, second, and third positions on the list are occupied by ordinary users' requests, the fourth position is occupied by a VIP user's request, the fifth, sixth, and seventh positions are occupied by ordinary users' requests, the eighth position is occupied by a VIP user's request, and so on. In an embodiment, positions of requests in the standby list for the resource can be assigned based on rules for accommodating requests for a specific time period along with requests for any available access right. For example, when the rule specifies requests for any available access right can be inserted after every two requests for a specific time period, the first and second positions on the list are occupied by requests for a specific time period, the third position is occupied by a request for any available time, the fourth and fifth positions are occupied by requests for a specific time period, the sixth position is occupied by a request for any available time, and so on.

In an embodiment, users of the system can earn points as loyalty rewards for their use of the system. For example, a user can earn points based on the number of times the user uses the system, the amount spent in access fees, the amount spent during use of the access right, or any other suitable metric. In one example, the user can use the points to move to a higher position in the standby list. In another example, the user can use the points in lieu of paying the access fee.

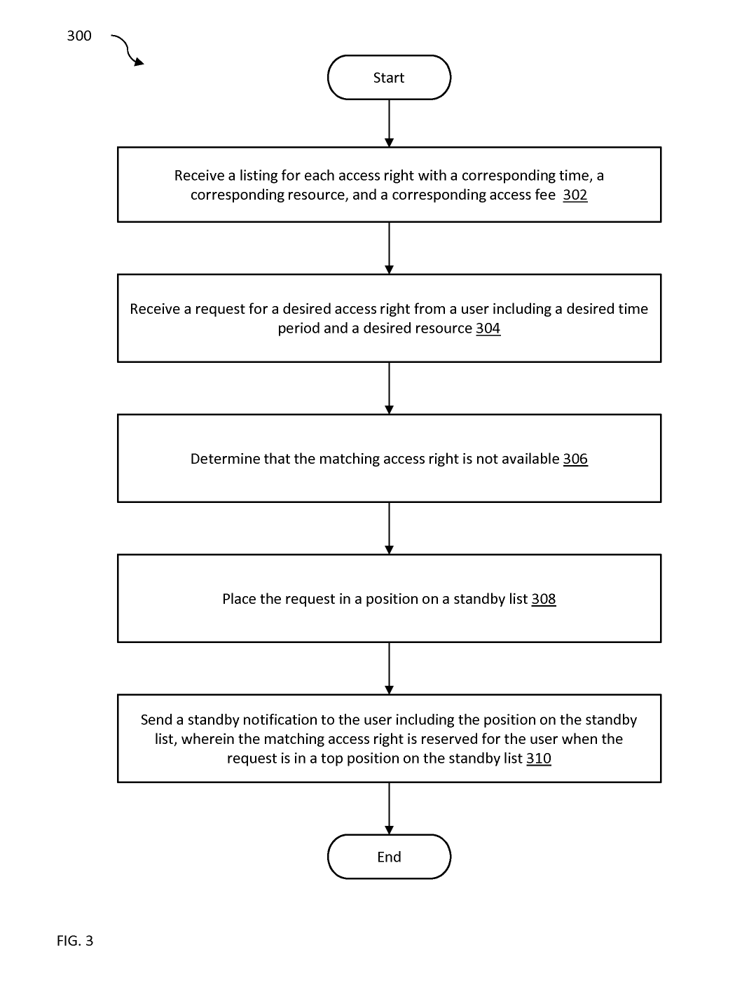

FIG. 3 is a flow diagram illustrating an embodiment for a method 300 of managing access rights. The method 300 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 300 is performed by a server (e.g., the provider server 110 of FIG. 1).

At block 302, processing logic receives listings for access rights, where a corresponding time and a corresponding resource for each access right are provided by an access right holder. In an embodiment, an access right holder can provide a list of access rights (e.g., reservations) with corresponding times for a particular resource (e.g., a restaurant), where each of the access rights is for a certain number of people. Further, the access right holder can provide a list of access rights with corresponding times for more than one resource (e.g., different restaurants). In an embodiment, multiple access rights holders can provide lists of access rights, each with a corresponding time and resource. The access right holder or system manager can also indicate an access fee associated with each access right, where the access fee can be the same for each access right, or the access fee can be variable based on aspects, as indicated by the access right holder or system manager. The access right holder or system manager can also provide an aspect for determining which user to assign to an access right, and can also provide an aspect for determining a position on a standby list for a request if an access right is not available.

At block 304, processing logic receives a request for a desired access right from a user including a desired time period and a desired resource. For example, a user could request a reservation between 8 pm and 10 pm on Friday for Restaurant A for 4 people. Processing logic can determine a matching access right. For example, a matching access right has a corresponding time that is within the desired time period, and is for a resource that matches the desired resource. A desired access right could have multiple matching access rights if multiple access rights have corresponding times and matching resources. In the example above, a matching access right could be a reservation at 9 pm on Friday for Restaurant A for a table that seats 4 people.

At block 306, upon determining one or more matching access rights, processing logic can determine that none of the matching access rights is available. For example, the matching access right would not available if the matching access right has already been reserved for another user. However, a matching access right could become available if the matching access right is not reserved for another user, or the access right holder adds more access rights.

At block 308, processing logic places the request on a standby list if the matching access right is not available. In an embodiment, if more than one request is on the standby list, then the request can be placed on the standby list in order of arrival, or the request can be placed on the standby list based on the aspect provided by the access right holder. Further to the example above, the restaurateur could have indicated that users that have not been able to successfully reserve a table previously be placed in a position higher on the standby list than users that have been able to successfully reserve a table previously.

At block 310, processing logic sends a standby notification to the user including the position on the standby list. For example, the standby notification can be sent to the user by email, text, voicemail, or any other suitable method. In another example, the user can indicate the method desired for receiving a standby notification. Further, the matching access right can be reserved for the user when the request is in a top position on the standby list.

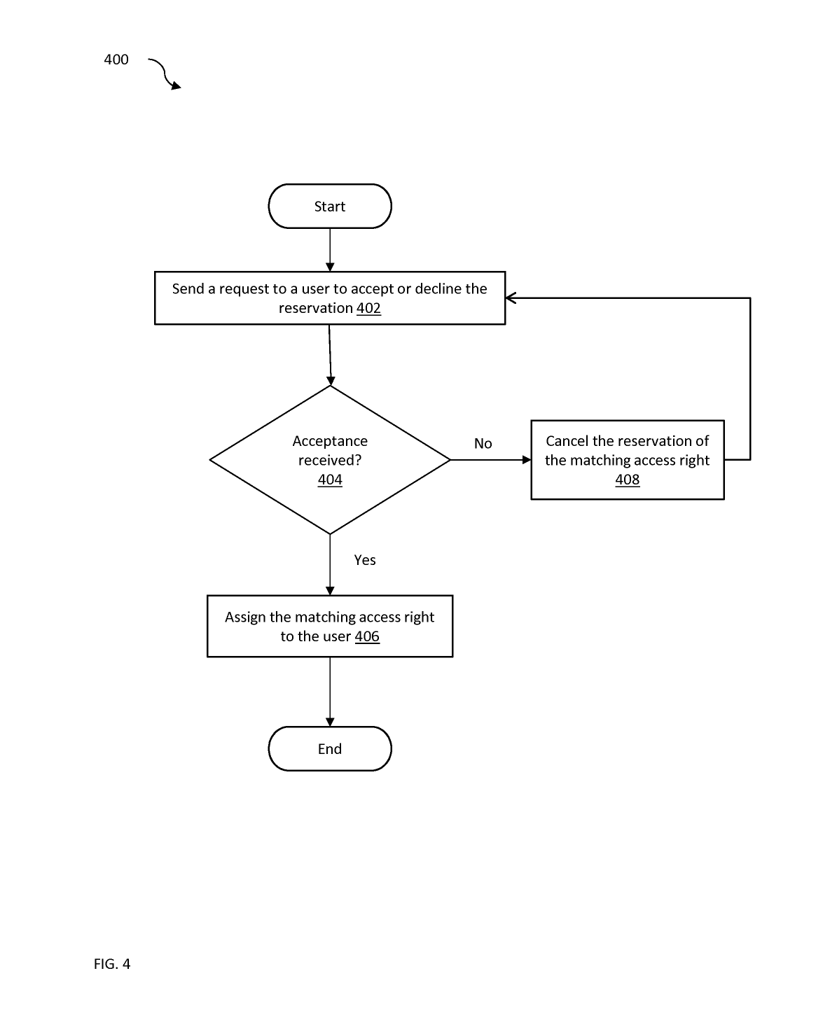

FIG. 4 is a flow diagram illustrating an embodiment for a method 400 of managing access rights, where an access right has been reserved for a user based on the user's request. The method 400 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 400 is performed by a server (e.g., the provider server 110 of FIG. 1).

In block 402, processing logic sends a request to a user to accept or decline a reservation 402. In block 404, processing logic determines whether an acceptance has been received. For example, the user could receive an email or a text prompting a response from the user to either accept or reject the reservation.

In block 406, upon determining that an acceptance has been received, processing logic assigns the access right to the user 406. For example, the user could send a text or an email indicating that the user is accepting the reservation. In an embodiment, if an access fee is associated with the access right, then the access fee is charged to the user. For example, a credit or debit card can be automatically charged if the reservation is accepted.

In block 408, upon determining that a declination has been received, processing logic cancels the reservation of the matching access right such that the matching access right is then available for another user (e.g., a request in the next position in the standby list). In an embodiment, if the acceptance is not received within a certain time period (e.g., a time period designated by the access right holder or system manager), then lack of acceptance within the certain time period is considered a declination, and the reservation is canceled.

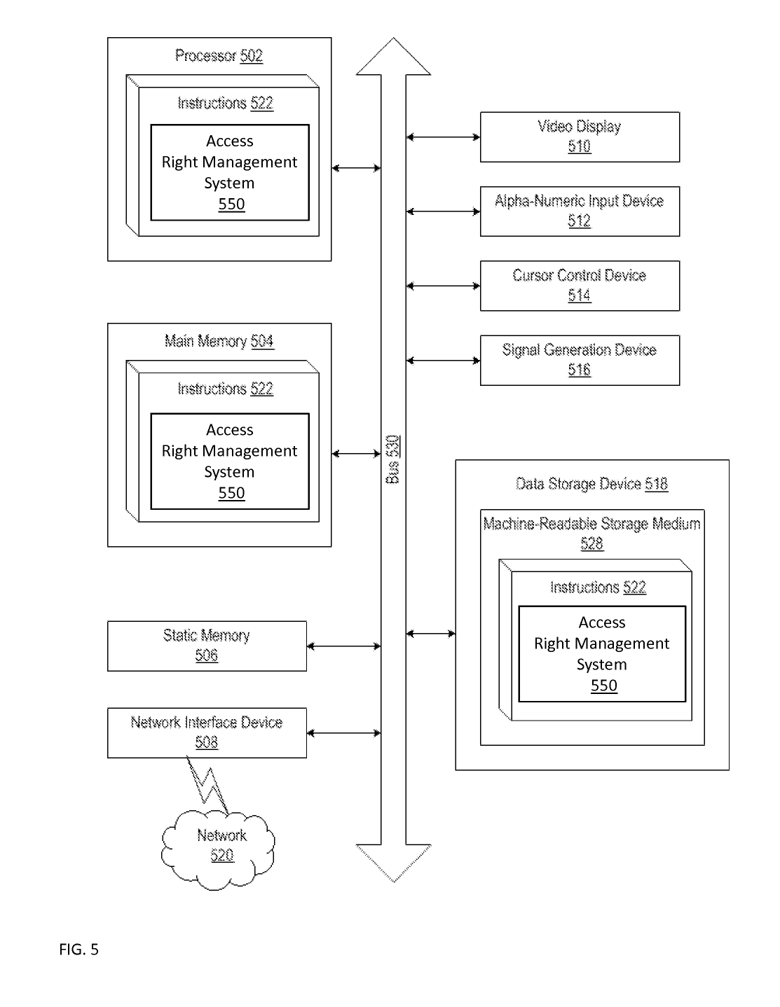

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device (processor) 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 may also be one or more special-purpose processing devices such as an application specific integrated circuit (ASIC), a field programmable gate array (FPGA), a digital signal processor (DSP), network processor, or the like. The processor 502 is configured to execute instructions 526 for performing the operations and steps discussed herein.

The computer system 500 may further include a network interface device 522. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 518 may include a computer-readable storage medium 524 on which is stored one or more sets of instructions 526 (e.g., software) embodying any one or more of the methodologies or functions described herein. The instructions 526 may also reside, completely or at least partially, within the main memory 504 and/or within the processor 502 during execution thereof by the computer system 500, the main memory 504 and the processor 502 also constituting computer-readable storage media. The instructions 526 may further be transmitted or received over a network 516 via the network interface device 522.

In one embodiment, the instructions 526 include instructions for a access rights management system 550, which may correspond to access rights management system 135 of FIG. 1, and/or a software library containing methods that calculate a subscribability score for a channel. While the computer-readable storage medium 524 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “computing”, “calculating”, “obtaining”, “identifying,” “modifying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

We claim:

1. A method comprising:
receiving, by a processing device, a listing for each of a plurality of access rights, each access right having a corresponding time, a corresponding resource, and a corresponding access fee;
receiving, by the processing device, a request for a desired access right from a user, wherein the request comprises a desired time period and a desired resource;
determining, by the processing device, a matching access right of the plurality of access rights, wherein the corresponding time of the matching access right is within the desired time period and the corresponding resource of the matching access right matches the desired resource;
determining that the matching access right is not available;
placing, by the processing device, the request in a position on a standby list; and
sending, to the user, a standby notification comprising the position on the standby list, wherein the matching access right is reserved for the user when the request is in a top position on the standby list.

2. The method of claim 1, further comprising:
upon reservation of the matching access right for the user, sending a request to the user to accept or decline the reservation;
upon receipt of an acceptance of the reservation by the user, assigning the matching access right to the user; and
upon receipt of a declination of the reservation by the user, canceling the reservation of the matching access right such that the matching access right is available for another user.

3. The method of claim 2, wherein the reservation is canceled when the acceptance of the reservation is not received within an acceptance time period.

4. The method of claim 2, further comprising:
requesting payment of the corresponding access fee by the user upon acceptance of the reservation of the matching access right, wherein the assigning of the matching access right is upon receipt of the corresponding access fee.

5. The method of claim 4, further comprising receiving an aspect for the corresponding access fee, wherein the corresponding access fee is based on the aspect.

6. The method of claim 2, wherein, when the user accepts the reservation and does not use the access right at the corresponding time, the user is assessed a cancellation fee.

7. The method of claim 1, further comprising receiving an aspect for the standby list, wherein the position on the standby list is based on the aspect.

8. The method of claim 1, further comprising:
determining that less than a certain period of time is left prior to a corresponding time of a last-minute access right of the plurality of access rights;
determining a user within a certain distance from a corresponding resource of the last-minute access right; and
sending a last-minute notification to the user, wherein the last-minute notification comprises the corresponding time of the last-minute access right, the corresponding resource of the last-minute access right, and a request to the user to accept or decline an assignment of the last-minute access right.

9. A non-transitory computer readable storage medium having instructions that, when executed by a processing device, cause the processing device to perform operations comprising:
receiving, a listing for each of a plurality of access rights, each access right having a corresponding time, a corresponding resource, and a corresponding access fee;
receiving a request for a desired access right from a user, wherein the request comprises a desired time period and a desired resource;
determining a matching access right of the plurality of access rights, wherein the corresponding time of the matching access right is within the desired time period and the corresponding resource of the matching access right matches the desired resource;
determining that the matching access right is not available;
placing the request in in a position on a standby list; and
sending, to the user, a standby notification comprising the position on the standby list, wherein the matching access right is reserved for the user when the request is in a top position on the standby list.

10. The non-transitory computer readable storage medium of claim 9, wherein the operations further comprise:
upon reservation of the matching access right for the user, sending a request to the user to accept or decline the reservation;
upon receipt of an acceptance of the reservation by the user, assigning the matching access right to the user; and
upon receipt of a declination of the reservation by the user, canceling the reservation of the matching access right such that the matching access right is available for another user.

11. The non-transitory computer readable storage medium of claim 10, wherein the reservation is canceled when the acceptance of the reservation is not received within an acceptance time period.

12. The non-transitory computer readable storage medium of claim 10, wherein the operations further comprise requesting payment of the corresponding access fee by the user upon acceptance of the reservation of the matching access right, wherein the assigning of the matching access right is upon receipt of the corresponding access fee.

13. The non-transitory computer readable storage medium of claim 12, wherein the operations further comprise receiving an aspect for the corresponding access fee, wherein the corresponding access fee is based on the aspect.

14. The non-transitory computer readable storage medium of claim 10, wherein, when the user accepts the reservation and does not use the access right at the corresponding time, the user is assessed a cancellation fee.

15. The non-transitory computer readable storage medium of claim 9, wherein the operations further comprise receiving an aspect for the standby list, wherein the position on the standby list is based on the aspect.

16. A computing device comprising:
a memory; and
a processing device coupled to the memory, wherein the processing device is to:
receive, a listing for each of a plurality of access rights, each access right having a corresponding time, a corresponding resource, and a corresponding access fee;
receive a request for a desired access right from a user, wherein the request comprises a desired time period and a desired resource;
determine a matching access right of the plurality of access rights, wherein the corresponding time of the matching access right is within the desired time period and the corresponding resource of the matching access right matches the desired resource;
determining that the matching access right is not available;
place the request in a position on a standby list; and
send, to the user, a standby notification comprising a position on the standby list, wherein the matching access right is reserved for the user when the request is in a top position on the standby list.

17. The computing device of claim 16, wherein the processing device is further to:
upon reservation of the matching access right for the user, send a request to the user to accept or decline the reservation;
upon receipt of an acceptance of the reservation by the user, assign the matching access right to the user; and
upon receipt of a declination of the assignment by the user, cancel the reservation of the matching access right such that the matching access right is available for another user.

18. The computing device of claim 17, wherein the reservation is canceled when the acceptance of the reservation is not received within an acceptance time period.

19. The computing device of claim 17, wherein the processing device is further to request payment of the corresponding access fee by the user upon acceptance of the reservation of the matching access right, wherein the assigning of the matching access right is upon receipt of the corresponding access fee.

20. The computing device of claim 19, wherein the processing device is further to receive an aspect for the corresponding access fee, wherein the corresponding access fee is based on the aspect.

21. The computing device of claim 17, wherein, when the user accepts the reservation and does not use the access right at the corresponding time, the user is assessed a cancellation fee.

22. A method comprising:
receiving, by a processing device, a listing for each of a plurality of access rights, each access right having a corresponding resource and a corresponding access fee;
receiving, by the processing device, a request for a desired access right from a user, wherein the request comprises a desired resource;
determining, by the processing device, a matching access right of the plurality of access rights, wherein the corresponding resource of the matching access right matches the desired resource;
determining that the matching access right is not available;
placing, by the processing device, the request in a position on a standby list; and sending, to the user, a standby notification comprising the position on the standby list, wherein the matching access right is reserved for the user when the request is in a top position on the standby list.
